(19) United States
(12) Patent Application Publication
(10) Pub. No.: US 2002/0194278 A1
(43) Pub. Date: Dec. 19, 2002

(54) System and method for e-mail correction

(76) Inventor: Michael Golan, Tel Aviv (IL)

Correspondence Address: DR. D. GRAESER, C/O THE POLKINGHORNS, 9003 FLORIN WAY, UPPER MARLBORO, MD, 20772, US

(21) Appl. No.: 09/823,972

(22) Filed: Apr. 3, 2001

(51) Int. Cl. G06F 15/16

(52) U.S. Cl. 709/206; 709/203

(57) ABSTRACT

A system and a method for transparently correcting a transmitted message, which could optionally be an e-mail message for example. Preferably, only the corrected version of the message is displayed to the recipient. Most preferably, the recipient only knows that the message is a corrected version of a previous message according to a notification, which is optionally and most preferably displayed in the context of the corrected message.

### FIELD AND BACKGROUND

The present invention is of a system and method for correcting a transmitted message, and in particular, for correcting a transmitted e-mail message after such a transmitted e-mail message has already been received by the recipient. The system and method preferably operate by determining the last message transmitted from the transmitting user to the recipient, and then incorporating that message as an attachment.

Many different types of electronic messaging systems are currently used today for instantaneous or near-instantaneous communication between users, through a variety of computational devices, such as personal computers, handheld computers and even cellular telephones. E-mail (electronic mail) is probably the most widely used and cost-effective form of contemporary electronic messaging systems. However, although such instantaneous electronic messaging systems have many advantages, they also have their fair share of shortcomings. The inability of the user to retrieve or otherwise block transmission of a message, once it has been sent from the computational device of the user, is perhaps the most frustrating of these shortcomings. Users often send messages, only to realize (or to be informed) a few moments later that the message contained erroneous information or embarrassing mistakes, such as spelling mistakes for example.

At present, the only way to correct a transmitted e-mail message is to re-send or forward a corrected version of the e-mail message. However, both re-sending and especially forwarding of the message have their drawbacks. For example, in order to re-send an e-mail message, users have to access their “sent mail” folder, double-click on or otherwise select the erroneous message, make the necessary changes and finally, click on “send”.

To forward an e-mail message, users have to access their “sent mail” folder through the e-mail messaging software program, highlight the erroneous message, click on “forward”, make the necessary changes and finally, click on “send”. Moreover, even if the user re-sends or forwards an amended e-mail message, the original transmitted message still remains in the recipient's “inbox”, or storage area for received messages. This increases the chances of the original e-mail message being read before the amended message.

Clearly, a system is needed which allows the user to send a revised message without having to go through the lengthy procedure involved in forwarding or re-sending, and whereby the user can “replace” the original message with an amended message. Unfortunately, such a system is not currently available.

### SUMMARY OF THE INVENTION

The present invention is of a system and a method for correcting a transmitted message, which could optionally be an e-mail message for example, in a manner which is transparent both to the user who originally sent the message and to the recipient of the message. Preferably, only the corrected version of the message is displayed to the recipient. Most preferably, the recipient only knows that the message is a corrected version of a previous message according to a notification, which is optionally and most preferably displayed in the context of the corrected message.

According to preferred embodiments of the present invention, there is provided a method for correcting a transmitted message by a transmitting user, the method comprising the steps of: (a) correcting the transmitted message by the transmitting user to form a corrected message; (b) transmitting the corrected message to the recipient; and (c) replacing the transmitted message with the corrected message.

According to another embodiment of the present invention, there is provided a system for correcting a transmitted e-mail message by a transmitting user, the system comprising: (a) a e-mail software program for transmitting the transmitted e-mail message; (b) an e-mail server for receiving the transmitted e-mail message; and (c) a correction module for correcting the transmitted e-mail message to form a corrected e-mail message, the corrected e-mail message being transmitted to the e-mail server.

Hereinafter, the term “network” refers to a connection between any two or more computational devices which permits the transmission of data.

Hereinafter, the term “computational device” includes, but is not limited to, personal computational devices (PC) having an operating system such as DOS, Windows™, OS/2™ or Linux; Macintosh™ computational devices; computational devices having JAVA™-OS as their operating system; graphical workstations such as the computational devices of Sun Microsystems™ and Silicon Graphics™, and other computational devices having some version of the UNIX operating system such as AIX™ or SOLARIS™ of Sun Microsystems™; or any other known and available operating system, or any device, including but not limited to: laptops, hand-held computational devices, PDA (personal data assistant) devices, cellular telephones, any type of WAP (wireless application protocol) enabled device, wearable computational devices of any sort, and any device which can be connected to a network as previously defined and which has an operating system. Hereinafter, the term “Windows™” includes but is not limited to Windows95™, Windows NT™, Windows98™, Windows CE™, Windows2000™, and any upgraded versions of these operating systems by Microsoft Corp. (USA).

Hereinafter, the term “cellular telephone” refers to any type of wireless or cordless device, which is capable of data transfer through a radio frequency signal, optionally through a connection to the PSTN (public switched telephone network).

Hereinafter, the term “recipient” is used to generally refer to the user who receives an electronic message and/or the device which receives such a message. Furthermore, the device which receives such a message could further be characterized as being one or both of a computational or other electronic device which actually physically receives the message, and a server or other computational device for temporarily storing the message, an example of which would be an e-mail server that temporarily spools e-mail messages until they are retrieved by the recipient.

Hereinafter, the term “inbox” refers to an e-mail inbox or an electronic storage facility for receiving incoming messages.

For the present invention, a software application could be written in substantially any suitable programming language, which could easily be selected by one of ordinary skill in the art. The programming language chosen should be compatible with the computational device according to which the software application is executed. Examples of suitable programming languages include, but are not limited to, C, C++ and Java.

In addition, the present invention could be implemented as software, firmware or hardware, or as a combination thereof For any of these implementations, the functional steps performed by the method could be described as a plurality of instructions performed by a data processor.

Every e-mail program has its own unique features. However, for illustration purposes, all examples of e-mail messages contained in this document are based on the Netscape Messenger™ e-mail program as a non-limiting example of such a program.

### BRIEF DESCRIPTION OF THE DRAWINGS

The invention is herein described, by way of example only, with reference to the accompanying drawings, wherein:

FIG. 1 is a schematic block diagram of an exemplary embodiment of a system according to the present invention;

FIG. 2 shows an example of the original message as an inconspicuous attachment at the bottom of the amended message; and

FIG. 3 is a flowchart of an exemplary method according to the present invention.

### DESCRIPTION OF THE PREFERRED EMBODIMENTS

The present invention is of a system and a method for transparently correcting a transmitted message, which could optionally be an e-mail message for example. Preferably, only the corrected version of the message is displayed to the recipient. Most preferably, the recipient only knows that the message is a corrected version of a previous message according to a notification, which is optionally and most preferably displayed in the context of the corrected message.

With regard to the implementation of the present invention for e-mail message, most preferably, only the corrected version of the e-mail message appears in the inbox of the receiving user. Optionally and most preferably, the previously transmitted, incorrect e-mail message, is only present as an inconspicuous attachment to the corrected, primary e-mail message.

The present invention thus has a number of clear advantages over background art message correction methods, as there are numerous reasons why the transmitting user might wish to prevent, or at least discourage, the receiving user from reading the original message. For example, the receiving user would presumably not appreciate spelling mistakes in the e-mail message. In addition, the transmitting user may have made a critical mistake in the original e-mail message, such as a critical factual error for example, which would be important to block or cover in order to prevent misinforming the receiving user. Furthermore, since the first receiving user may optionally forward the e-mail message to other users, clearly correcting mistakes in the “inbox” of the first receiving user is also crucial to prevent further complications.

In short, the system and method of the present invention have three distinct advantages over currently available background art methods. First, the present invention reduces the possibility of the original, incorrect, e-mail message being read. Second, the present invention saves time and effort, over forwarding corrected messages, for example. Third, the present invention is more user-friendly.

The principles and operation of the present invention may be better understood with reference to the drawings and the accompanying description.

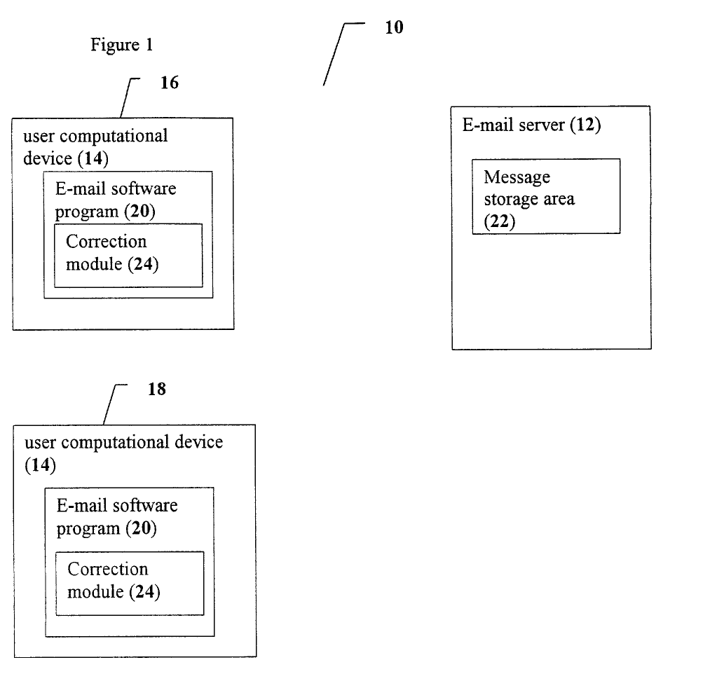

Referring now to the drawings, FIG. 1 is a schematic block diagram of a first exemplary embodiment of a system according to the present invention. Although the present invention is described with regard to e-mail messaging systems, it is understood that this is for the purposes of description only and is without any intention of being limiting.

A system 10 according to the present invention features an e-mail server 12 for passing e-mail messages between a plurality of user computational devices 14, including a transmitting device 16 and a receiving device 18. Each user computational device 14 features an e-mail software program 20, for preparing and transmitting e-mail messages, and for displaying received e-mail messages to the user. Each user computational device 14 communicates with e-mail server 12 for transmitting and receiving e-mail messages.

As is well known in the art, e-mail software program 20 of transmitting device 16 prepares an e-mail message for transmission to receiving device 18. Peer-to-peer messaging systems are well known in the art and are included within the scope of the present invention. However, for the purposes of illustration only, system 10 requires the e-mail message to be first transmitted from transmitting device 16 to e-mail server 12. In fact, e-mail server 12 may optionally be one of a plurality of such servers to which the e-mail message must be sent before reaching its final destination.

The e-mail message includes an e-mail address for indicating the intended recipient. Such an e-mail address corresponds to a particular message storage area 22 on e-mail server 12, known as the “e-mail spooler”, which typically holds messages for a plurality of such e-mail addresses. Once e-mail software program 20 of receiving device 18 communicates with e-mail server 12 by transmitting the required identification information for a particular e-mail address, the appropriate e-mail message(s) are retrieved from message storage area 22 and are sent to receiving device 18. Either or both message storage area 22 and e-mail software program 20 of receiving device 18 may therefore optionally be stated to have an “inbox” for e-mail messages.

The present invention further improves upon the above system 10, by enabling the transmitting user to correct a previously transmitted e-mail message through e-mail software program 20 of transmitting device 16. As shown, e-mail software program 20 preferably features a correction module 24. Correction module 24 enables such corrections to be made in a manner which is more preferably transparent to both the transmitting and the receiving users.

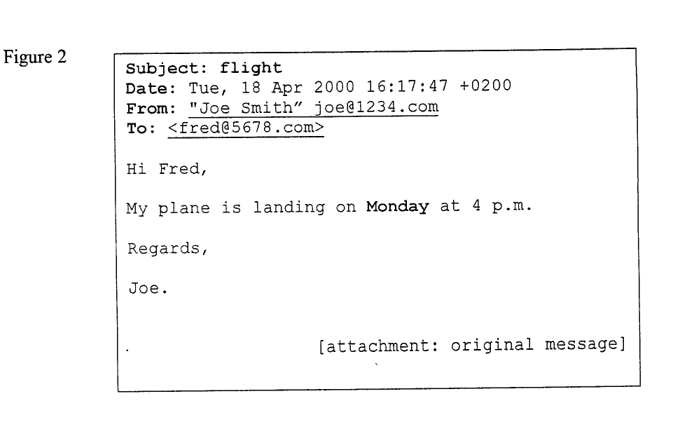

Most preferably, according to the present invention, only the corrected version of the e-mail message appears in the inbox of the receiving user. Optionally and most preferably, the previously transmitted, incorrect e-mail message, is only present as an inconspicuous attachment to the corrected, primary e-mail message. FIG. 2 shows an illustrative, non-limiting example of such a corrected e-mail message, with the original, incorrect e-mail message shown as an attachment at the bottom of the corrected message.

Preferred embodiments of the present invention can be described with regard to the exemplary implementation of the present invention with e-mail messaging systems. E-mail messages are always preceded by a series of headers, with each e-mail software program having its own set of headers. The basic headers, which are typically the visible headers and which are usually displayed by most programs, inform the recipient of the transmitting e-mail message address, when the message was sent, the intended recipient e-mail address, and the subject of the e-mail message.

The following example illustrates how a message would normally appear to the recipient user through the Netscape Messenger™ e-mail program:

Subject: flight
Date: Tue, 18 Apr 2000 16:17:47 +0200
From: “Joe Smith” joe@1234.com
To: <fred@5678.com>
Hi Fred,
My plane is landing on Sunday at 4 p.m.
Regards,
Joe.

If the same recipient were to click on “View” and select the “all headers” option, all of the Netscape Messenger™ headers would be displayed, as shown below:

Received: from falcon (unverified [232.646.345.92]) by poulenc.table.com
(EMWAC SMTPRS 0.8) with SMTP id
<B0000166375@poulenc.table.com>; Tue, 18 Apr 2000 16:18:34 +0200

Message-ID:

<006f01bfa940$df8e28a0$44646464@goldenlines.net.il>

From: “Joe Smith” <joe@1234.com>
To: <fred@5678.com>
Subject: flight
Date: Tue, 18 Apr 2000 16:17:47 +0200
MIME-Version: 1.0
Content-Type: multipart/alternative;

boundary=“----=_NextPart_000_006C_01BFA951.A2C30C40”

X-Priority: 3
X-MSMail-Priority: Normal
X-Mailer: Microsoft Outlook Express 5.00.2314.1300
X-MimeOLE: Produced By Microsoft MimeOLE V5.00.2314.1300
X-Mozilla-Status: 8001
X-Mozilla-Status2: 00000000
X-UIDL: B0000166375.MSG
Hi Fred,
My plane is landing on Sunday at 4 p.m.
Regards,
Joe.

As previously described, the headers which appear in the above example are typical of the Netscape Messenger™ program. The amount and function of the headers varies between e-mail software programs, with each header fulfilling a separate function.

According to preferred embodiments of the present invention, an additional header is included in each e-mail message, which enables the original e-mail message to be corrected. For example, such an additional header could optionally be added by correction module 24. The presence of the additional header preferably enables correction module 24 to locate the original message and to incorporate the original message as an attachment to the new, corrected e-mail message. In other words, the original message would more preferably no longer appear as a separate message in the recipient's inbox. Instead, the original message would appear as an inconspicuous attachment at the bottom of the amended message, as shown for example with regard to FIG. 2.

The main goal of the present invention is to enable transmitting users to amend an already transmitted message before the receiving user reads the message. Optionally and more preferably, the present invention is also useful for other types of situations. For example, if the amended e-mail message arrives before the original message, and the receiving user opens the “inbox” before the original message arrives, the above attachment procedure could not be immediately performed. Instead, when the original, incorrect e-mail message arrives, optionally and preferably correction module 24 would recognize the incorrect message and would initiate the attachment procedure as described above, thereby causing the incorrect e-mail message to become an attachment for the corrected message.

As another example, if the amended message arrives before the original message, the receiving user could then read and delete the amended message before receipt of the original, incorrect e-mail message. The present invention preferably handles this situation according to the choice of the user. For example, the user could optionally configure correction module 24 to perform one of the following actions: move the amended message from the “Trash”, or area for deleted messages, back to the “inbox”, and then incorporate the original message as an attachment; or delete the original message if preceded by the amended message.

As yet another example, the receiving user could read the original message before the amended message arrives. In this situation, correction module 24 preferably clearly marks the amended message as a correction for display to the receiving user upon opening the “inbox”.

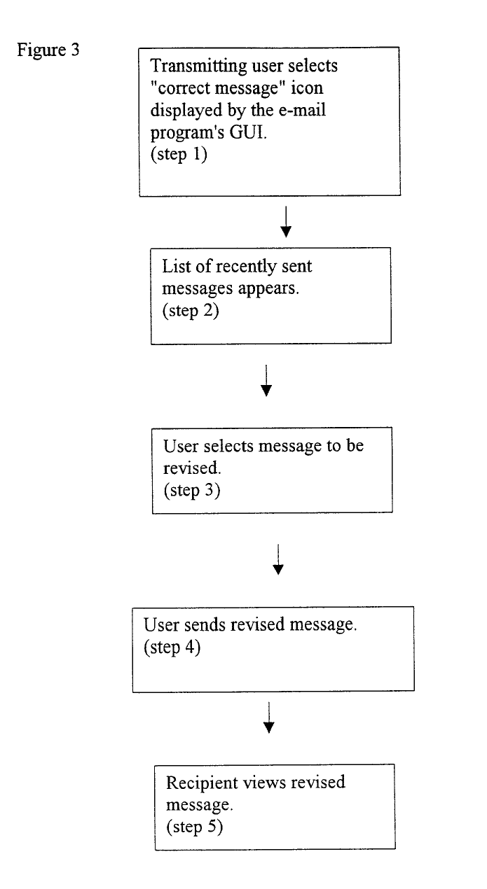

An exemplary correction method according to the present invention is described with regard to the flowchart of FIG. 3, again explained with regard to e-mail messaging systems for the purpose of description only and without any intention of being limiting. As shown, in step 1, the transmitting user (hereinafter referred to as the “user”) chooses to correct a transmitted e-mail message, for example by selecting the “correct message” icon as displayed by the GUI (graphical user interface) for the e-mail software program.

In step 2, a list of recently sent messages appears. In step 3, the user selects the message to be revised and makes the required revisions to that message. In step 4, the revised message is sent. In step 5, the recipient user (hereinafter the “recipient”) then views the corrected message as displayed by the e-mail message software program of the recipient.

The original message would appear as shown in the example below (line numbers have been added for reference purposes):

1.Subject: flight
2.Date: Tue, 18 Apr 2000 16:17:47 +0200
3.From: “Joe Smith” joe@1234.com
4.To: <fred@5678.com>
5.Correction-status: mesg 1123842348
Hi Fred,
My plane is landing on Sunday at 4 p.m.
Regards,
Joe.

The new header (line 5), which is optionally and preferably automatically added by the present invention, would normally be hidden. The string of characters after “mesg” enables correction module 24 to locate the original e-mail message in the recipient's inbox. In addition, these characters also provide a mechanism for safeguarding the integrity of the present invention for purposes of security.

If the recipient selects the “view all headers” option, the amended message would appear as displayed below (line numbers have been added for reference purposes):

1. Received: from falcon (unverified [232.646.345.92]) by poulenc.table.com
(EMWAC SMTPRS 0.8) with SMTP id <B0000166375@poulenc.table.com>;
Tue, 18 Apr 2000 16:18:34 +0200

2. Message-ID:

<006f01bfa940$df8e28a0$44646464@goldenlines.net.il>

3. From: “Joe Smith” <joe@1234.com>
4. To: <fred@5678.com>
5. Subject: CORRECTION TO MESG: flight
6. Correction-status: mesg 887348986 replace mesg 1123842348
7. Date: Tue, 18 Apr 2000 16:17:47 +0200
8. MIME-Version: 1.0
9. Content-Type: multipart/alternative;

boundary=“----=_NextPart_000_006C_01BFA951.A2C30C40”

10. X-Priority: 3
11. X-MSMail-Priority: Normal
12. X-Mailer: Microsoft Outlook Express 5.00.2314.1300
13. X-MimeOLE: Produced By Microsoft MimeOLE V5.00.2314.1300
14. X-Mozilla-Status: 8001
15. X-Mozilla-Status2: 00000000
16. X-UIDL: B0000166375.MSG
Hi Fred,
My plane is landing on Monday at 4 p.m.
Regards,
Joe.
[attachment: original message]

In the “Subject” line (5), the message “CORRECTION TO MESG:” appears followed by the subject.

The “Correction-status” line (6) provides information on the replacement action: the correction module has located message 1123842348 (the original e-mail message) and incorporated it as an attachment for message 887348986 (the amended message). It is important to stress that the correction headers shown in the above example would more preferably normally be hidden from view. Most preferably, the only visible indication that the message is a correction would be the attachment at the end of the message.

The recipient would normally see the corrected e-mail message as shown in greater detail below:

Subject: flight
Date: Tue, 18 Apr 2000 16:17:47 +0200
From: “Joe Smith” joe@1234.com
To: <fred@5678.com>
Hi Fred,
My plane is landing on Monday at 4 p.m.
Regards,
Joe.

[attachment: original message]

According to other preferred embodiments of the present invention, the transmitting user can also optionally perform any number of corrections to a corrected message that has already been sent. In this situation, the present invention more preferably treats the first corrected message as the original message, and incorporates it as an attachment to the second corrected message, and so forth. Thus, more preferably the last corrected message is displayed to the recipient, while all previously corrected messages, as well as the original message, become attachments to the last corrected message, which are optionally nested.

If an original message is sent with an attachment and must then be corrected, the transmitting user is optionally and more preferably able to amend the message without sending the attachment again. Instead, the correction module would more preferably simply take the attachment from the original message, and attach it to the amended message. This feature is especially useful when the attachment is large, such that re-sending the attachment could require a great deal of time and/or bandwidth.

According to preferred embodiments of the present invention, the e-mail message is optionally sent to a plurality of receiving users, even after the original e-mail message has been sent. For example, suppose that the sender, or transmitting user, has already sent an e-mail message to recipients (receiving users) A and B, and now wishes to send the same e-mail message to recipient C. In this case, the only difference between the two messages would be the addition of another recipient to the “to:” header, which would therefore be the correction.

Optionally, the e-mail message could only be sent to the new recipient, indicating the names of the other recipient(s). In this case, the e-mail message would preferably contain a header listing the names and/or e-mail addresses of the other recipients.

For example, an e-mail message sent to Jim Jones, which had previously been sent to Fred Bloggs and Mary Smith, would optionally and preferably appear with the following header:

Message also sent to: Fred Bloggs and Mary Smith

Alternatively, the corrected e-mail message could be sent to all recipients, including the new recipient. The new recipient would preferably receive the message marked “new”, with the “to:” header including the other recipients of the message, e.g. “to: Jim Jones, Fred Bloggs, Mary Smith”. The original recipients would also preferably receive the corrected message, which would incorporate the original message as an attachment (see below for a more detailed explanation).

Also alternatively, rather than sending the entire corrected message to recipients who had previously received the original e-mail message, preferably a “patch” would be included, informing the original recipients that the message has now been sent to another recipient or recipients. More preferably, the original recipients would also be informed that the only change to the original message is the addition of another recipient.

As an extension of this optional but preferred implementation, only the corrections to the original e-mail message would optionally and preferably be sent to all of the original recipients of the original message, rather than sending the entirety of the corrected message. The transmitting user, however, would more preferably send the corrected message exactly as previously described, such that the transmitting user would send the entire corrected message. A software program implemented according to the present invention would then compare the original e-mail message with the amended e-mail message and send only the corrections. The corrections would be incorporated into the original message at the inbox of the recipient or receiving user. This optional but preferred implementation would have the advantage of possibly reducing the time and/or bandwidth which is required to send the amended message, especially if the message text is long and the corrections are relatively few.

This “patching” option would be particularly useful for the transmission of e-mail messages within a corporation or other organization, where each user's e-mail software program would preferably be enabled with the method of the present invention, and would thus support sending and receiving such patches, or corrections alone.

According to other preferred embodiments of the present invention, the sender, or transmitting user, would preferably have the option of including a “Type of correction” header in the corrected message being sent. The header would more preferably be followed by a short description of the type of correction. For example, the header could optionally state “Type of correction: Spelling in line 4”.

According to other preferred embodiments of the present invention, there are provided security features for preventing unauthorized access to the e-mail messages. Optionally and most preferably, each new e-mail message is allocated a unique string of characters, or code, through which the e-mail message can be identified, located, and corrected if necessary. The e-mail software program of the transmitting user allocates a different code for each new message. Since no two codes are the same, the possibility of a third party deliberately replacing an e-mail message is eliminated.

According to the previously described embodiment of the present invention, the correction module is a required feature for the e-mail software programs of both the transmitting and receiving users. However, even if only the e-mail software program of the transmitting user has such a correction module, the present invention is optionally still operative as follows. The e-mail software program of the recipient is still able to receive the amended message. In this case, the amended message optionally and more preferably displays a “correction” header in the subject line. For example, the subject line could state “Subject: CORRECTION TO MESG: patent”.

According to optional but preferred embodiments of the present invention, a message is, preferably automatically, displayed to a user whose e-mail software program does not feature the correction method of the present invention. When such a receiving user accesses an e-mail message which is sent from a transmitting user whose e-mail software program is so enabled, the displayed message more preferably enable the receiving user to obtain a software program or module which would at least feature the correction method of the present invention, optionally as part of a complete e-mail software program. For example, the receiving user could optionally order the software program or module through the Internet, through a link to a Web site provided with the message. Alternatively, the location of a physical, “bricks and mortar” store could optionally be provided, or at least a pointer to an information source for locating such a store, such that the receiving user would purchase the software program or module from the store. The pointer to the information source could be a telephone number, for example.

According to other preferred embodiments of the present invention, delayed transmissions are optionally and preferably provided. E-mail messages are often “spooled”, or stored, on local mail servers until the receiving user examines received e-mail messages. For example, through the e-mail and Web browser software program Netscape™, this procedure is performed by clicking the “Get Msg” button of the GUI (graphical user interface)).

Preferably, the method of the present invention enables spooled messages to be replaced with corrected messages while the original messages are still stored on the mail server, i.e. before the receiving user accesses these messages.

According to a preferred implementation of the present invention, the present invention would optionally be implemented as a software program on the central mail server rather than on each individual e-mail software program. Such an implementation could have the advantages of being both more cost effective and easier to install. However, the functionality of the present invention would be impaired, since messages could only be corrected when stored on the central mail server, but not after the original messages had been retrieved from the central mail server by the receiving user (if such original messages are simultaneously deleted from the central mail server during the downloading process).

The method of the present invention optionally and more preferably includes a “confirmation” feature which preferably informs the sender, or transmitting user, when the corrected e-mail message has been accessed. This feature is more preferably enabled/disabled by the receiving user.

The confirmation feature would be useful if the sender (transmitting user) wished to know, with some degree of certainty, that the receiving user had in fact accessed the corrected message, but would most preferably only be operative if the receiving user had the “confirmation” option enabled.

While the invention has been described with respect to a limited number of embodiments, it will be appreciated that many variations, modifications and other applications of the invention may be made.

What is claimed is:

1. A method for correcting a transmitted message by a transmitting user, the method comprising:
correcting the transmitted message by the transmitting user to form a corrected message;
transmitting the corrected message to the recipient; and
replacing the transmitted message with the corrected message.

2. The method of claim 1, wherein the transmitted message and the corrected message are both e-mail messages.

3. The method of claim 2, wherein the transmitted message is replaced with the corrected message at the recipient.

4. The method of claim 2, wherein the transmitted message is received by a e-mail server and wherein the transmitted message is replaced with the corrected message as an attachment at said e-mail server.

5. The method of claim 2, wherein the transmitted message is replaced with the corrected message by adding the transmitted message as an attachment to the corrected message.

6. The method of claim 5, wherein the transmitted message is added to the corrected message at the recipient.

7. The method of claim 6, wherein a plurality of corrected e-mail messages are sent, such that a plurality of transmitted incorrect e-mail messages is formed, said plurality of transmitted incorrect e-mail messages being added to a final corrected e-mail message as nested attachments at the recipient.

8. The method of claim 5, wherein the transmitted message is received by a e-mail server and wherein the transmitted message is added to the corrected message as an attachment at said e-mail server.

9. The method of claim 5, wherein only the corrected message is displayed to the recipient.

10. The method of claim 2, wherein the corrected message is identical to the transmitted message, except for an additional recipient, such that an original recipient of the transmitted message only receives a message concerning said additional message, and only said additional recipient receives the corrected message.

11. The method of claim 2, wherein only a message indicating at least one specific correction is sent to the recipient as the corrected message.

12. The method of claim 2, wherein each transmitted message receives a unique identifying code for securely locating and correcting the transmitted message.

13. The method of claim 1, wherein only the corrected message is displayed to the recipient.

14. A system for correcting a transmitted e-mail message by a transmitting user, the system comprising:
(a) an e-mail software program for transmitting the transmitted e-mail message;
(b) an e-mail server for receiving the transmitted e-mail message; and
(c) a correction module for correcting the transmitted e-mail message to form a corrected e-mail message, said corrected e-mail message being transmitted to said e-mail server.

15. The system of claim 14, further comprising:
(d) a transmitting device for operating said e-mail software program and said correction module; and
(e) a receiving device for receiving at least said corrected e-mail message from said e-mail server.

16. The system of claim 15, wherein said receiving device receives both the transmitted e-mail message and said corrected e-mail message.

17. The system of claim 16, wherein said corrected e-mail message replaces the transmitted e-mail message.

18. The system of claim 16, wherein the transmitted e-mail message is added to said corrected e-mail message as an attachment.

19. The system of claim 18, wherein a plurality of corrected e-mail messages are sent, such that a plurality of transmitted incorrect e-mail messages is formed, said plurality of transmitted incorrect e-mail messages being added to a final corrected e-mail message as nested attachments.

20. The system of claim 14, further comprising:
(d) a transmitting device for operating said e-mail software program and said correction module; and
(e) a receiving device for receiving a message from said e-mail server concerning said correction module, such that said receiving device can only receive said corrected message if said receiving device operates said correction module.

21. The system of claim 20, wherein said receiving device does not operate said correction module, and said message provides information for obtaining said correction module.

22. The system of claim 14, wherein said correction module is operated by said e-mail server.
